(19) United States
(12) Patent Application Publication
(10) Pub. No.: US 2007/0187975 A1
(43) Pub. Date: Aug. 16, 2007

(54) Tinted window liners for automobiles

(76) Inventor: Geoff Magal, Forest Hills, NY (US)

Correspondence Address: LITMAN LAW OFFICES, LTD., P.O. BOX 15035, CRYSTAL CITY STATION, ARLINGTON, VA, 22215, US

(21) Appl. No.: 11/353,187

(22) Filed: Feb. 14, 2006

(51) Int. Cl. B60J 3/00

(52) U.S. Cl. 296/97.1

(57) ABSTRACT

The tinted window liners for automobiles include a tinted window liner for removable attachment to a front side window of an automobile and a tinted window liner for removable attachment to a rear side window of an automobile. The front window liner includes an inner shield and an outer shield that are connected to form a one-piece tint line for placement over the top of the window. The rear window liner has only an inner shield with a curved top edge for hanging over the top edge of the window. Both the front and rear liners include adhesive strips that allow the liners to be easily installed and removed during times when they are not needed. The liners may also be part of a kit that allows for easier installation, cleaning, storage, and transportation.

### BACKGROUND OF THE INVENTION

1. Field of the Invention

The present invention relates to automobile accessories, and more specifically to tinted window liners for automobiles that are removably attachable to the side windows of an automobile.

2. Description of the Related Art

Vehicle operators and passengers are frequently subjected to high intensity light from the sun, bright sky, lights of passing vehicles, etc., which is bothersome, fatiguing and even dangerous if the glare is sufficient to cause even momentary blindness. Automobile manufacturers and others skilled in the art have attempted to cope with these problems by providing windshields with tinted strips across the upper edge portion thereof or permanent window tinting. These products are highly restricted to particular small areas, or heavily tinted and permanent so that they are dangerous to operate the vehicle after dark because the reduction in light transmission is too great to permit good vision at night out the side window. Permanent tint also has a disadvantage in that it starts to wear over time and can bubble up and eventually peel off.

There is a need for a tinted window liner that can be constructed and used for the side windows of all years, makes, and models of automobiles. It is also desirable that these liners be easily installable and be capable of being easily removed during times when they are not needed. Thus, tinted window liners for automobiles solving the aforementioned problems are desired.

### SUMMARY OF THE INVENTION

The tinted window liners for automobiles include a tinted window liner for removable attachment to a front side window of an automobile and a tinted window liner for removable attachment to a rear side window of an automobile.

The tinted window liner for removable attachment to a front side window of an automobile includes an inner shield for covering the inside surface of the window, an outer shield for covering the outside surface of the window, at least one adhesive strip attached along an interior surface of the inner shield for securing the tinted window liner to the window, and at least one adhesive strip attached along an interior surface of the outer shield for securing the tinted window liner to the window. The top edge of the inner shield is permanently connected to the top edge of the outer shield, resulting in a one-piece liner that is designed to fit over the top edge of the window it is being used on. The liner may also include a padded strip along the interior of this joined top edge for receiving the top edge of the window. The liner may further include a guide hook that extends away from the liner for keeping the liner in alignment as the window in use is being rolled up and down.

The tinted window liner for removable attachment to a rear side window of an automobile includes an outer shield for covering the outside surface of the window and at least one adhesive strip attached along an interior surface of the outer shield for securing the tinted window liner to the window. The outer shield has a top edge, with a portion of the top edge being curved so that it is adapted to hang over the top edge of the window.

These and other features of the present invention will become readily apparent upon further review of the following specification and drawings.

### BRIEF DESCRIPTION OF THE DRAWINGS

FIG. 1 is an environmental side view of a tinted window liner for automobiles according to the present invention, shown in use on a front side window of an automobile.

FIG. 1A is a partial environmental side view of a portion of a tinted window liner for automobiles according to the present invention, with a portion of the automobile broken away to expose the guide hook.

FIG. 2A is a section view drawn along lines 2A-2A of FIG. 1.

FIG. 2B is a section view drawn along lines 2B-2B of FIG. 1.

FIG. 3 is an environmental side view of a tinted window liner for automobiles according to the present invention, shown in use on a rear side window of an automobile.

FIG. 4A is a section view drawn along lines 4A-4A of FIG. 3.

FIG. 4B is a section view drawn along lines 4B-4B of FIG. 3.

FIG. 5A is a perspective view of a handheld hook tool for use in a kit for installing tinted window liners for automobiles according to the present invention.

FIG. 5B is a perspective view of a scrub brush for use in a kit for installing tinted window liners for automobiles according to the present invention.

FIG. 5C is a perspective view of a carrying case for use in a kit for installing tinted window liners for automobiles according to the present invention.

Similar reference characters denote corresponding features consistently throughout the attached drawings.

### DETAILED DESCRIPTION OF THE PREFERRED EMBODIMENTS

The present invention is tinted window liners for automobiles. A tinted window liner for removable attachment to a front side window of an automobile is designated generally as 10 in the drawings. A tinted window liner for removable attachment to a rear side window of an automobile is designated generally as 10a in the drawings.

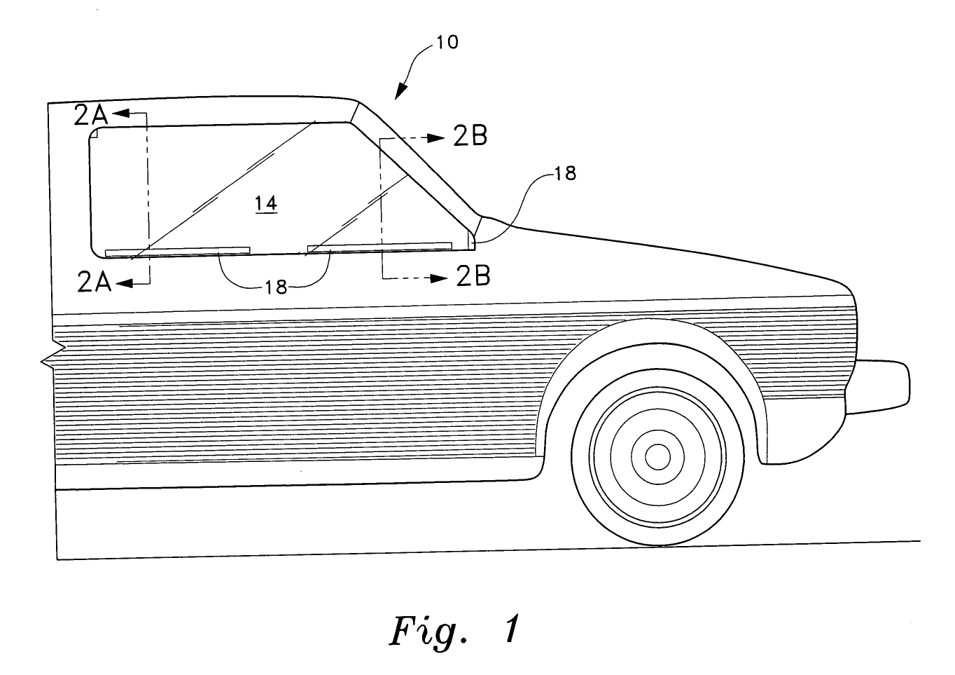

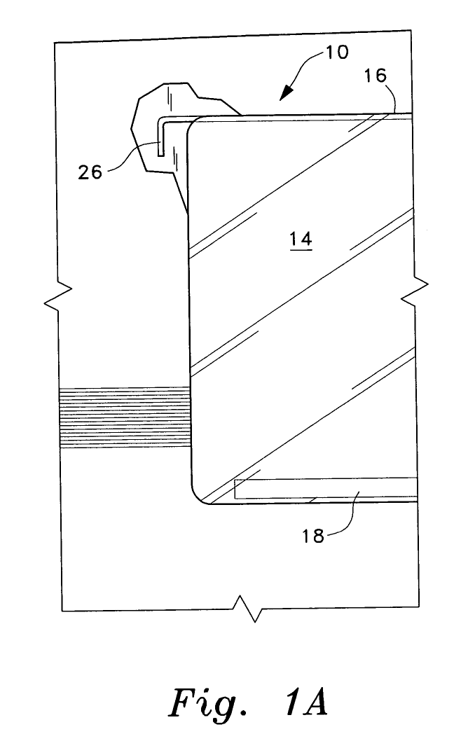

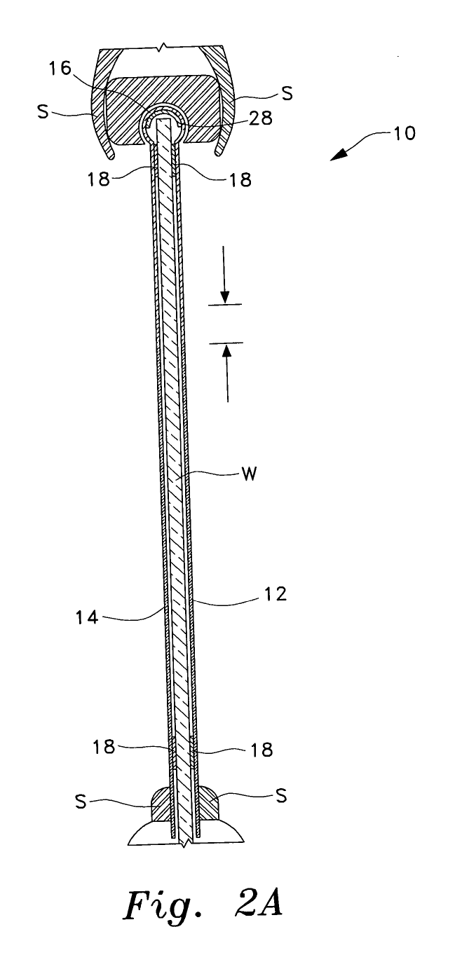

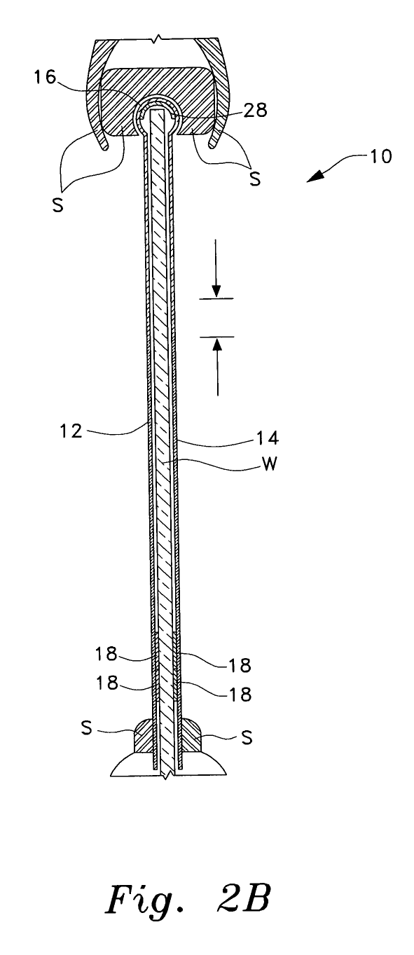

Referring to FIGS. 1, 1A, 2A, and 2B, tinted window liner 10 includes an inner shield 12, and outer shield 14, at least one adhesive strip 18 attached along an interior surface of inner shield 12, and at least one adhesive strip 18 attached along an interior surface of outer shield 14. Inner shield 12 has a top edge and a bottom edge and is dimensioned to completely cover the inside surface of window W, such that inner shield 12 rests between weather stripping S and window W and the bottom edge of inner shield 12 rests at least partially below the weather stripping S along the bottom edge of the window opening when window W is in a completely closed position. It is conventional for weather stripping S to be so referenced when referring to the lower portion of window W, however, along the upper portion of window W, it is referred to as rubber channel S.

Outer shield 14 has a top edge and a bottom edge and is dimensioned to completely cover the outside surface of window W, such that inner shield 12 rests between weather stripping S and window W and the bottom edge of outer shield 14 rests at least partially below the weather stripping S along the bottom edge of the window opening when window W is in a completely closed position. The entire top edge of outer shield 14 is connected to the entire top edge of inner shield 12, resulting in joined top edge 16, which allows liner 10 to be a one-piece apparatus that is adapted to fit over the top edge of window W. Joined top edge 16 is adapted to fit tightly within, or just below, rubber channel S that is found around the top edge of the window opening when window W is in a closed position. Adhesive strips 18 are attached along an interior surface of inner shield 12 and outer shield 14 for securing tinted window liner 10 to window W.

Tinted window liner 10 may also include padded strip 28. Padded strip 28 is permanently affixed to tinted window liner 10 along the interior of the entire length of joined top edge 16. Padded strip 28 is designed to protect the top edge of window W when it is on its way up and it starts sliding in rubber channel S of window W. The tinted window liner 10 may also include guide hook 26. Guide hook 26 is permanently attached to tinted window liner 10 at a point adjacent to joined top 16 and extends away from tinted window liner 10 toward the rear of window W. Guide hook 26 is designed to engage the rubber channel found along the side of the window opening in the automobile so that tinted window liner 10 remains aligned as the window is rolled up and down.

Inner shield 12 and outer shield 14 may be made from tinted plastic and have uniform thickness from the top edge to the bottom edge. However, each have a variable hardness, with the hardness of each being at a maximum near the top edge and gradually decreasing to a lesser hardness at a point beginning about a third of the way between the top edge and the bottom edge.

Inner shield 12 and outer shield 14 may each be equipped with four adhesive strips 18 along each of their interior surfaces, with each adhesive strip 18 being a static strip.

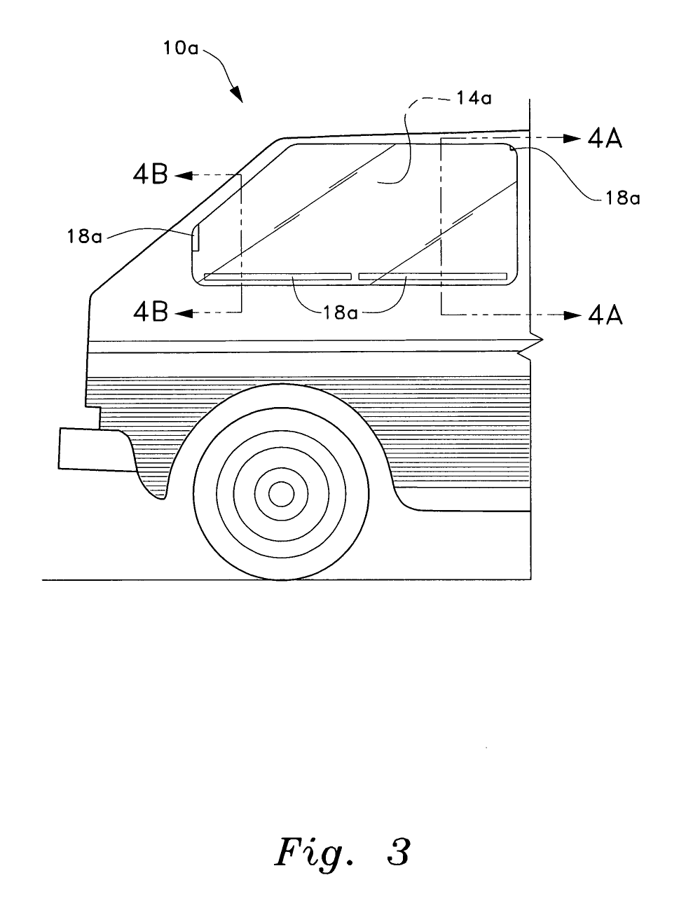

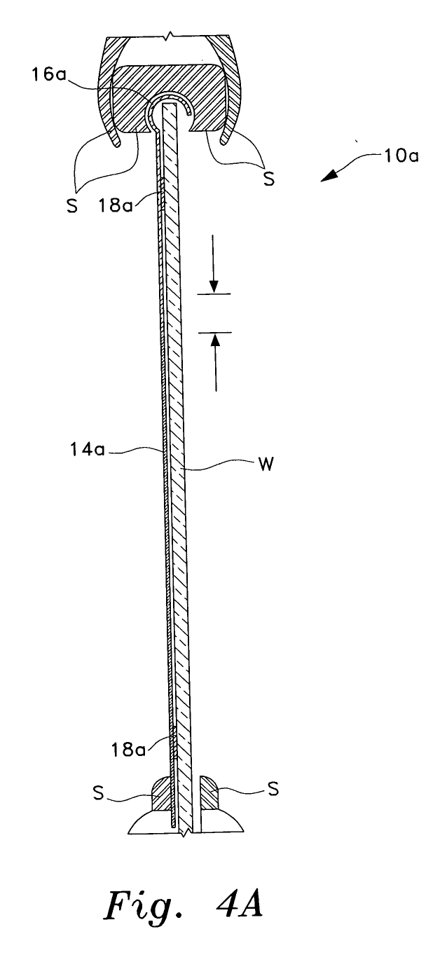

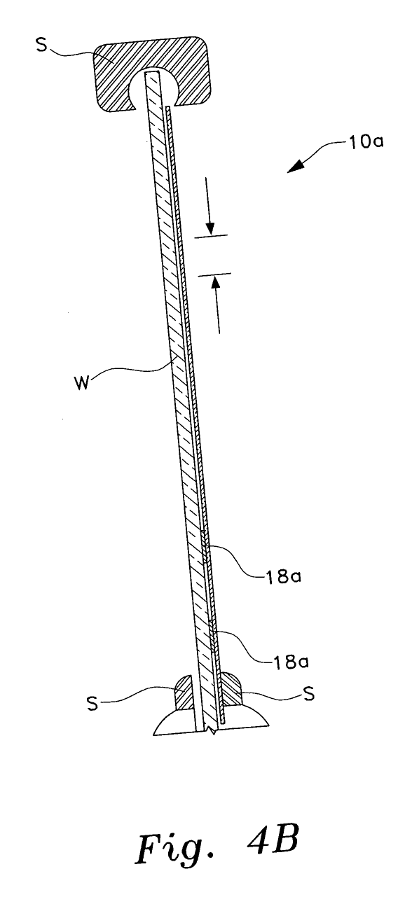

Turning now to FIGS. 3, 4A, and 4B, tinted window liner 10a for removable attachment to a rear side window of an automobile is shown having an inner shield 14a and at least one adhesive strip 18a. Inner shield 14a has a top edge and a bottom edge and is dimensioned to completely cover the inside surface of window W, so that the bottom edge of inner shield 14a rests below the rubber channel S along the bottom edge of the window opening when window W is in a completely closed position.

A portion of the top edge of inner shield 14a, the portion associated with the straight, horizontal portion of window W, is curved to form curved top edge 16a so that it is adapted to hang over the top edge of window W. Curved top edge 16a is adapted to fit tightly within rubber channel S that is found around the top edge of the window opening when window W is in a closed position. The sloped, upper edge portion of window W is not covered by a curved top edge so that tinted window liner 10a rests parallel to window W along this portion, such that the top edge of inner shield 14a is flush with rubber channel S when window W is closed. Adhesive strips 18a are attached along an interior surface of inner shield 14a for securing tinted window liner 10a to window W.

Inner shield 14a may be made from tinted plastic and have a uniform thickness from the top edge to the bottom edge. However, inner shield 14a has a variable hardness, with the hardness being at a maximum near the top edge and gradually decreasing to a lesser hardness at a point beginning about a third of the way between the top edge and the bottom edge. Tinted window liner 10a may also include a guide hook designed to engage the rubber channel found along the side of the window opening in the automobile so that tinted window liner 10a remains aligned as the window is rolled up and down.

Inner shield 14a may be equipped with four adhesive strips 18a along the interior surface, with each adhesive strip 18a being a static strip.

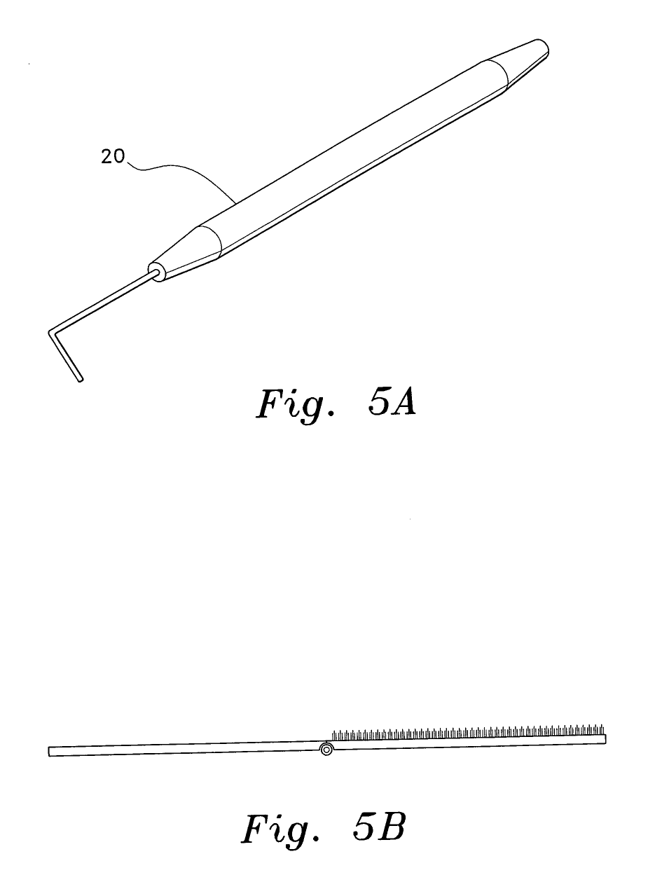

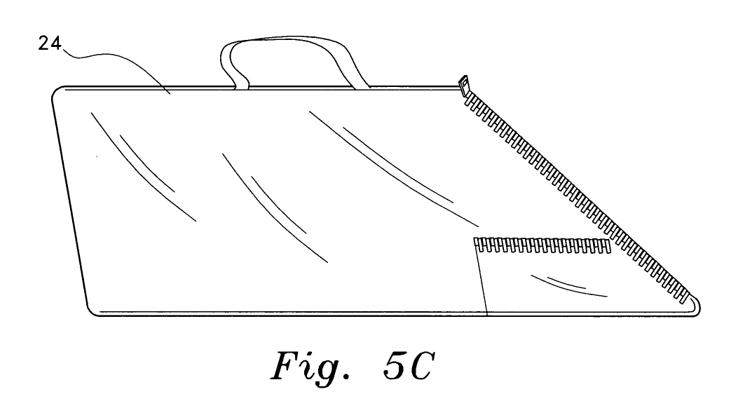

Referring to FIGS. 5A, 5B, and 5C, the tinted window liners discussed above may be included in a kit along with handheld hook tool 20, foldable scrub brush 22, and carrying case 24. Tool 20 is used to help pry away the rubber channel around a window opening when attempting to install and use a tinted window liner. Foldable scrub brush 22 is used to clean between the shields of the tinted window liners when they are not in use on a window. Carrying case 24 is shaped to fit the various tinted window liners and can be used for storage and transportation of the liners, as well as having a pouch for carrying the other tools.

It is to be understood that the present invention is not limited to the embodiments described above, but encompasses any and all embodiments within the scope of the following claims.

I claim:

1. A tinted window liner for removable attachment to a front side window of an automobile, comprising:
an inner shield for covering the inside surface of the window, the inner shield having a top edge and a bottom edge;
an outer shield for covering the outside surface of the window, the outer shield having a top edge and a bottom edge, the top edge of the outer shield being connected to the top edge of the inner shield so that the liner is adapted to fit over the top edge of the window;
at least one adhesive strip attached along an interior surface of the inner shield for securing the tinted window liner to the window; and
at least one adhesive strip attached along an interior surface of the outer shield for securing the tinted window liner to the window.

2. The tinted window liner according to claim 1, further comprising a padded strip permanently affixed to the tinted window liner along the entire length adjacent to the connection of the top edge of the outer shield and the top edge of the inner shield.

3. The tinted window liner according to claim 2, further comprising a guide hook permanently attached to the tinted window liner adjacent to the connection of the top edge of the outer shield and the top edge of the inner shield and extending away from the tinted window liner.

4. The tinted window liner according to claim 1, wherein the hardness of the inner shield varies from the top edge to the bottom edge.

5. The tinted window liner according to claim 1, wherein the hardness of the outer shield varies from the top edge to the bottom edge.

6. The tinted window liner according to claim 1, wherein the at least one inner shield adhesive strip comprises four adhesive strips attached along an interior surface of the inner shield.

7. The tinted window liner according to claim 6, wherein the four adhesive strips comprise static strips.

8. The tinted window liner according to claim 1, wherein the at least one outer shield adhesive strip comprises four adhesive strips attached along an interior surface of the outer shield.

9. The tinted window liner according to claim 8, wherein the four adhesive strips comprise static strips.

10. A tinted window liner for removable attachment to a rear side window of an automobile, comprising:
an inner shield for covering the inside surface of the window, the inner shield having a top edge and a bottom edge, a portion of the top edge of the inner shield being curved so that the inner shield is adapted to hang over the top edge of the window; and
at least one adhesive strip attached along an interior surface of the inner shield for securing the tinted window liner to the window.

11. The tinted window liner according to claim 10, wherein the hardness of the inner shield varies from the top edge to the bottom edge.

12. The tinted window liner according to claim 10, wherein the at least one adhesive strip comprises four adhesive strips attached along an interior surface of the inner shield.

13. The tinted window liner according to claim 12, wherein the four adhesive strips comprise static strips.

14. A kit for tinting the windows of an automobile, comprising:
at least one front tinted window liner for removable attachment to a front side window of an automobile, the front liner having:
an inner shield for covering an inside surface of the window, the inner shield having a top edge and a bottom edge;
an outer shield for covering the outside surface of the window, the outer shield having a top edge and a bottom edge, the top edge of the outer shield being connected to the top edge of the inner shield so that the liner is adapted to fit over the top edge of the window;
at least one adhesive strip attached along an interior surface of the inner shield for securing the tinted window liner to the window; and
at least one adhesive strip attached along an interior surface of the outer shield for securing the tinted window liner to the window;
at least one rear tinted window liner for removable attachment to a rear side window of an automobile, the rear liner having:
an inner shield for covering the inside surface of the window, the inner shield having a top edge and a bottom edge, a portion of the top edge of the inner shield being curved so that the inner shield is adapted to hang over the top edge of the window; and
at least one adhesive strip attached along an interior surface of the inner shield for securing the tinted window liner to the window;
a handheld hook tool for installing the front liner and the rear liner;
a foldable scrub brush for cleaning the front liner and the rear liner; and
a case for holding and transporting the front and rear liners and the handheld hook tool and foldable scrub brush.
